(19) United States
(12) Patent Application Publication
(10) Pub. No.: US 2024/0332858 A1
(43) Pub. Date: Oct. 3, 2024

(54) RELIABLE HIGH SPEED ELECTRICAL CONNECTOR

(71) Applicant: Amphenol Commercial Products (Chengdu) Co., Ltd., Chengdu (CN)

(72) Inventors: Rui He, Chengdu (CN); Xiaodong Hu, Chengdu (CN); Yaohua Hou, Chengdu (CN)

(73) Assignee: Amphenol Commercial Products (Chengdu) Co., Ltd., Chengdu (CN)

(21) Appl. No.: 18/620,625

(22) Filed: Mar. 28, 2024

(30) Foreign Application Priority Data
Mar. 30, 2023 (CN) 202310334313.X
Mar. 30, 2023 (CN) 202320675582.8

(51) Int. Cl. H01R 13/52; H01R 12/72; H01R 43/00

(52) U.S. Cl. CPC H01R 13/5219; H01R 43/005; H01R 12/721

(57) ABSTRACT

A connector for reliably transmitting high-speed signals. The connector includes a housing having a mating face, a mounting face opposite the mating face, and channels extending to the mounting face. Conductive elements are disposed in respective channels, and each has a mounting end extending out of the mounting face. A seal is disposed at the mounting face. The seal includes a first sealing element (e.g., plastic) and a second sealing element (e.g., sealant). The second sealing element is stacked on the first sealing element. Subportions of the conductive element adjacent their mounting ends are embedded in the second sealing element. Such a configuration enables complete sealing of openings at the mounting face of the housing so as to block contaminants from entering the connector from the mounting face and enable the conductive elements to transmit high-speed signals (e.g., at a speed specified by DDR5 standard) reliably over time.

### CROSS-REFERENCE TO RELATED APPLICATIONS

This application claims priority to and the benefit of Chinese Patent Application Serial No. 202320675582.8, filed on Mar. 30, 2023. This application also claims priority to and the benefit of Chinese Patent Application Serial No. 202310334313.X, filed on Mar. 30, 2023. The contents of these applications are incorporated herein by reference in their entirety.

### TECHNICAL FIELD

The present application relates to interconnection systems, such as those including electrical connectors, configured to interconnect electronic assemblies.

### BACKGROUND

Electrical connectors are used in many electronic systems. It is easier and more cost effective to manufacture a system as separate electronic assemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

Computers, for example, are often manufactured with connectors that serve as sockets for memory cards. A memory card may contain one or multiple memory chips and may be inserted into a socket to increase the available memory in the computer. Memory cards have standardized electrical and mechanical interfaces, so as do the memory sockets. Many memory cards, for example, are designed according to DDR standard, such as DDR4 or DDR5.

### SUMMARY

Aspects of the present application relate to reliable high speed electrical connectors.

Some embodiments relate to an electrical connector. The electrical connector may include a housing comprising a mating face, a mounting face opposite the mating face, a side wall having a plurality of channels extending to the mounting face, and a slot recessed from the mating face and extending along the side wall; a plurality of conductive elements disposed in respective channels of the plurality of channels of the side wall of the housing, each of the plurality of conductive elements comprising a mating end having a mating contact portion curving into the slot, a mounting end extending out of the mounting face, and an intermediate portion joining the mating end and mounting end; and a seal disposed at the mounting face, the seal comprising a first sealing element and a second sealing element at least partially disposed on the first sealing element.

Optionally, the second sealing element extends beyond an edge of the first sealing element so as to block openings of the plurality of channels of the side wall of the housing at the mounting face.

Optionally, the first sealing element comprises plastic; and the second sealing element adheres to the first sealing element.

Optionally, the first sealing element comprises thermoplastic; and the second sealing element comprises silicon.

Optionally, the electrical connector may include a plurality of gaps between subportions of the intermediate portions of adjacent conductive elements of the plurality, wherein the second sealing element extends through the plurality of gaps to the side wall.

Optionally, the body of the housing is elongated in a longitudinal direction; and for each conductive element of the plurality of conductive elements, the intermediate portion is wider than the mounting end and engages the side wall of the housing so as to be restrained from moving in the longitudinal direction.

Optionally, for each of the plurality of conductive elements, the intermediate portion comprises a projection protruding away from the side wall of the housing and extend into the recesses of respective separators so as to be restrained from moving in a transverse direction perpendicular to the longitudinal direction.

Optionally, the first sealing element comprises a platform portion and a peripheral portion thinner than the platform portion and comprising the edge of the first sealing element; and

the second sealing element is disposed on the peripheral portion of the first sealing element and extends beyond the peripheral portion toward the side wall.

Optionally, the platform portion of the first sealing element comprises a plurality of grooves recessed from the mounting face.

Optionally, the wall comprises a stop at the mounting face and flush with the second sealing element; the mounting ends of the plurality of conductive elements bend towards a respective stop; and the second sealing element is disposed between the platform portion and the respective stops.

Optionally, the platform portion extends beyond the flushed surface of the second sealing element and the stop of the side wall.

Optionally, the electrical connector is configured to transmit signals at a speed specified by DDR5 standard.

Some embodiments relate to an electrical connector. The electrical connector may include a housing comprising a mating face, a mounting face opposite the mating face, and a plurality of channels extending to the mounting face; a plurality of conductive elements disposed in respective channels of the plurality of channels of the housing, each of the plurality of conductive elements comprising a mating end, a mounting end opposite the mating end and extending out of the plurality of channels at the mounting face, and an intermediate portion joining the mating end and mounting end; and a seal disposed at the mounting face of the housing, wherein, for each of the plurality of conductive elements: a subportion of the intermediate portion directly connected to the mounting end is embedded in the seal.

Optionally, the seal comprises plastic and sealant connected to the plastic; and the subportions of the intermediate portions of the plurality of conductive elements are embedded in the sealant of the seal.

Optionally, for each of the plurality of conductive elements: the mounting end is narrower than the subportion of the intermediate portion.

Optionally, the intermediate portion abuts the plastic of the seal and a respective side wall of the housing on opposite sides.

Optionally, the plastic of the seal comprises a platform portion and a peripheral portion surrounding the platform portion; and the intermediate portion is at least partial disposed between the peripheral portion of the plastic of the seal and the respective side wall of the housing.

Optionally, the sealant is stacked on the peripheral portion of the plastic; and the platform portion of the plastic is thicker than the stack of the sealant and the peripheral portion of the plastic.

Some embodiments relate to a method of manufacturing an electrical connector comprising a plurality of conductive elements held by a housing, the housing comprising a mating face, a mounting face opposite the mating face, a side wall having a plurality of channels extending to the mounting face, and a slot recessed from the mating face and extending along the side wall, and each of the plurality of conductive elements comprising a mating end, a mounting end, and an intermediate portion joining the mating end and mounting end. The method may include inserting the plurality of conductive elements into individual channels of the plurality of channels of the side wall of the housing such that, for each of the plurality of conductive element, a mating contact portion of the mating end curves into the slot, and the mounting end extends out of the mounting face; and disposing a seal at the mounting face of the housing comprising flowing a sealant around subportions of the intermediate portions of the plurality of conductive elements.

Optionally, the method may include curing the sealant such that the subportions of the intermediate portions of the plurality of conductive elements are embedded in the sealant.

Some embodiments relate to a card edge connector for mating with a mating component in a mating direction. The card edge connector may comprise: a housing, a plurality of conductive elements, and a seal. The housing may comprise two side walls extending in a longitudinal direction perpendicular to the mating direction. The two said side walls may define at least one slot extending in the longitudinal direction at a mating end of the housing in the mating direction. The two side walls each may be provided with a plurality of openings at a mounting end of the housing in the mating direction. The housing may further comprise a plurality of channels extending through the side walls via the openings. Each of the plurality of conductive elements may be held in a respective channel of the housing. Each of the plurality of conductive elements may comprise a mating contact portion that may curve into the slot, a mounting end that may extend out of the housing via the openings, and an intermediate portion, which may connect the mating contact portion and the mounting end. The seal may be provided at the mounting end of the housing and seal the openings. The intermediate portion of the conductive elements may be provided at a subportion adjacent to the mounting end. A gap is formed between the subportions of two adjacent ones of the conductive elements. The seal may extend through the gap and be connected to the side wall of the housing.

Optionally, the subportion of the conductive elements may have a greater width in the longitudinal direction than the mounting end.

Optionally, a projection may be provided on the surface of the intermediate portion of the conductive elements away from the corresponding side wall; and a recess may be provided on each of the two opposing surfaces of a separator between two adjacent ones of the channels and shaped to form a positive fit with the projection.

Optionally, the plurality of conductive elements may be arranged in the longitudinal direction in an array having two rows; the seal may comprise a first sealing element that may extend in the longitudinal direction and straddle the two rows of conductive elements in the direction transverse to the longitudinal direction; and two side parts of the first scaling element extending in the longitudinal direction may extend through the gap and be connected to the side walls of the housing.

Optionally, the plurality of conductive elements may be arranged in the longitudinal direction in an array having two rows; and the seal may comprise a first sealing element that may extend in the longitudinal direction and straddle the two rows of conductive elements in the direction transverse to the longitudinal direction and a second sealing element that may be provided on an edge of the first sealing element and extend beyond the edge of the first sealing element in the direction transverse to the longitudinal direction towards the corresponding side walls and be connected with the side walls.

Optionally, the first sealing element may comprise a platform portion and a peripheral portion having a thickness less than the platform portion in the mating direction; and the edge of the peripheral portion may be straight.

Optionally, the second sealing element may be provided on the peripheral portion of the first sealing element and extend beyond the peripheral portion in the direction transverse to the longitudinal direction towards the corresponding side wall of the housing and be connected with the side walls.

Optionally, the second sealing element may comprise silicon sealant.

Optionally, a plurality of grooves may be provided on the platform portion of the first sealing element; and the grooves in the mating direction may be thinner than the platform portion.

Optionally, the housing, the conductive elements and the first sealing element may be formed into one piece through injection-molding.

Optionally, the first sealing element and the housing may be configured as an integrated molded member of high temperature thermoplastic material.

Optionally, a stop may be provided on the mounting end of the side wall; and the mounting end of the conductive elements may bend towards the corresponding stop and may be embedded in the stop and forms a positive fit with the stop of the side walls.

Optionally, the stop may be flush with the seal.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a bottom perspective view of a card edge connector, showing a seal, according to some embodiments;

FIG. 2 is a bottom perspective view of the card edge connector of FIG. 1, with a part of the seal hidden and showing openings of a housing;

FIG. 3 is a top perspective view of the card edge connector of FIG. 1, showing a slot configured for receiving a mating component;

FIG. 4 is a cross-sectional, bottom perspective view of the card edge connector of FIG. 1;

FIG. 5 is another cross-sectional, bottom perspective view of the card edge connector of FIG. 1;

FIG. 6 is a cross-sectional, end view of the card edge connector of FIG. 1;

FIG. 7 is a side perspective view of conductive elements of the card edge connector of FIG. 1;

FIG. 8 is a front view of the conductive elements of FIG. 7; and

FIG. 9 is a perspective view of a portion of a first sealing element in the card edge connector.

### DETAILED DESCRIPTION

The inventors have recognized and appreciated techniques for making reliable high speed electrical connectors. The increasing transmission rate of electronic devices poses significant challenges for maintaining and/or improving the integrity of the signals passing through connectors. For example, for conventional card edge connectors, a housing has channels through which conductive elements can be inserted into the housing during manufacturing. These channels are sized larger than the conductive elements to enable the insertion.

The inventors have recognized and appreciated that the larger channels leave openings, for example, at a mounting surface configured to face a circuit board to which a connector can be mounted. The inventors have further recognized that the integrity of signals transmitted through the conductive elements of a conventional connector might be degraded because contaminations can enter into the channels through the openings. For example, contaminants may adhere to and/or accumulate on the conductive elements, causing poor contact between a mating component inserted into the connector and the conductive elements.

The inventors have recognized and appreciated connector designs to more completely seal the bottom of an electrical connector, including areas around the mounting ends of the conductive elements. Such a configuration more effectively blocks contaminants such as vaporized conformal coating, vaporized solder flux, etc., and in some examples may cooperate with other portions of the connector to completely seal the bottom or may completely block a path for contaminants from the bottom of the connector.

According to aspects of the present application, an electrical connector may have a housing having a slot elongated in a longitudinal direction and channels disposed on opposite sides of the slot. Each channel may extend through a mating face and a mounting face of the housing. Conductive elements may be held in individual channels, with mating ends having mating contact portions curving into the slot and mounting ends extending out of the channel from the mounting face of the housing. Each conductive element may have a portion wider than the mating portion and/or mounting end and disposed in recesses into side walls of the housing so as to reduce the risk of the conductive element moving in the longitudinal direction. The wider portion may have features configured to engage separators between the channels so as to reduce the risk of the conductive element moving in a transverse direction perpendicular to the longitudinal direction. The wider portion may have cutouts configured for sealant to fill therein. The configuration of the conductive element enables the bottom of the connector to be completely sealed and therefore capable of transmitting signals at high speed (e.g., a speed specified by DDR5 standard).

The connector may have a seal disposed at the mounting face. The seal may include a first sealing element and a second sealing element disposed around the first sealing element and configured to fix the first sealing element to the bottom of the connector. The first sealing element may have a platform portion such that the sealant can be disposed around the platform portion to form the second sealing element. The second sealing element may conform to subportions of the conductive elements so as to more completely block the openings. The center platform may have various recesses configured to reduce the risk of warping for the first sealing element. The first sealing element may be made of the same material of the connector housing such as high temperature thermal plastic. Any suitable sealant that has good fluidity, high temperature resistance, good insulation, and good sealing properties (e.g., silicone sealant) may be used.

According to aspects of the present application, a card edge connector may be provided with a seal, which may seal one side of the card edge connector that is configured to be connected to a PCB. The intermediate portion of conductive elements may be provided at a subportion adjacent to the mounting end. The two sides of the intermediate portion of conductive elements may be provided with cutouts. The subportions of adjacent conductive elements may form a positive fit with the seal such that conductive elements can engage the seal more tightly. For example, when the card edge connector is soldered to the PCB, the seal may block the solder vaporized due to high temperature from entering into the channels with conductive elements disposed therein through the bottom of the card edge connector. The seal may block other contaminants such as dust from entering channels. Such a configuration can enable the electrical connections provided by the connector to be reliable and stable and therefore enable the connector for high speed transmission and increase the connector's service life.

Next, an exemplary card edge connector according to the present application will be described in detail with reference to the drawings.

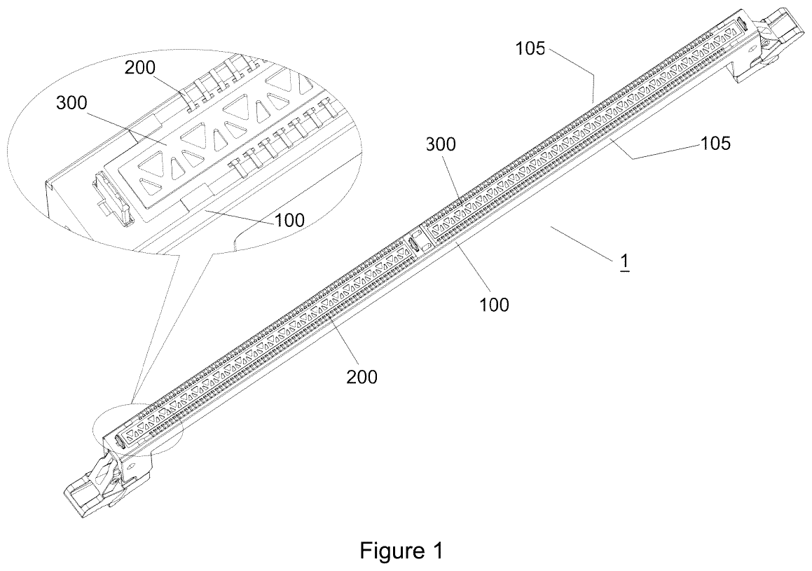

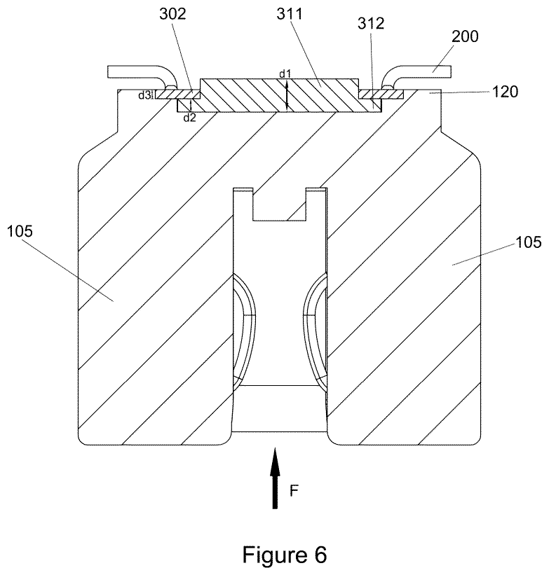

Referring to FIGS. 1 to 9, a card edge connector 1 according to an exemplary embodiment of the present application is shown. The card edge connector 1 may be electrically connected with a mating component at one end in a mating direction (indicated as the arrow F) and be electrically connected to a circuit board of electronic devices at the other end, connecting the mating component to the circuit board of electronic devices, such as computers. For example, the card edge connector 1 may be configured for receiving a memory card according to DDR5 standard.

The card edge connector 1 according to the exemplary embodiments of the present application may comprise a housing 100, a plurality of conductive elements 200, and a seal 300.

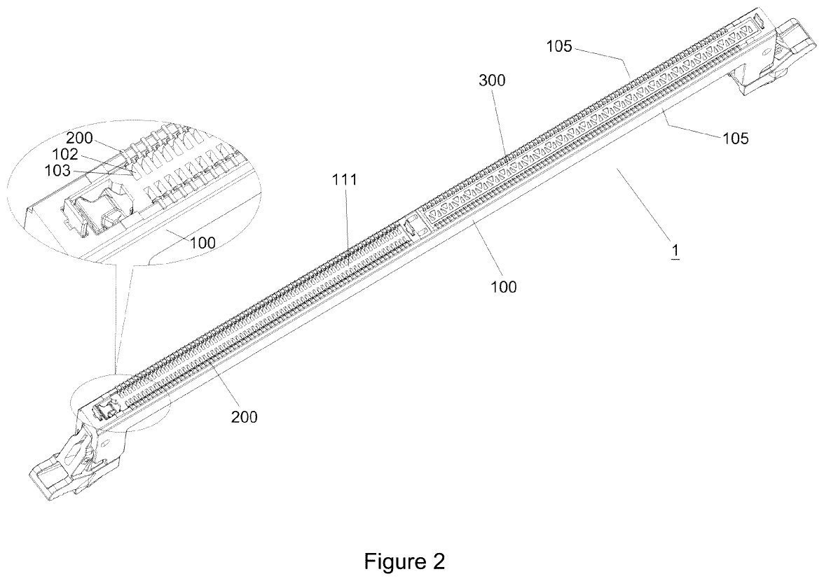

Referring to FIGS. 1 to 6, the housing 100 of the card edge connector 1 may comprise two side walls 105 extending in a longitudinal direction perpendicular to the mating direction F, the two side walls 105 defining at least one slot 101 at the mating end of the housing 100 in the mating direction F. The slot 101 may extend in the longitudinal direction and recess into the inside of the housing in the mating direction F. In some embodiments, the slot 101 may have an elongated shape in the longitudinal direction. The slot 101 may be configured for receiving a contact portion (not shown) of a mating card. As shown in FIG. 2, the two side walls 105 each may be further provided with a plurality of openings 102 at the mounting ends of the housing 100 in the mating direction. The openings 102 on each side wall 105 may be arranged in a row in the longitudinal direction. The housing 100 may also comprise a plurality of channels 103 extending through the side walls via the openings 102.

In some exemplary embodiments, the housing 100 may be made of insulating material such as plastic by molding process. In some exemplary embodiments, the housing 100 may be formed as an integrated element.

The term “mating end” may refer to the end for receiving a mating component such as a memory card inserted into the card edge connector 1 in the mating direction F. The term “mounting end” may refer to the end that is configured to face a circuit board to which the card edge connector may be mounted. “Mating end” and “mounting end” may refer to two opposing ends of the card edge connector 1 and/or the housing 100 in the mating direction F.

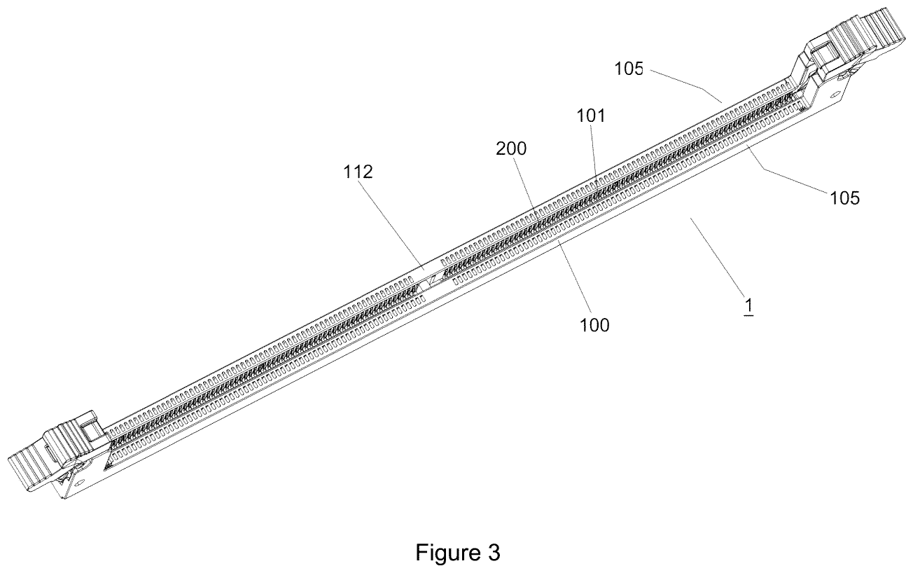

In some exemplary embodiments, as shown in FIG. 2, the housing 100 may comprise a mounting face 111 facing the circuit board to which the card edge connector 1 can be mounted. The openings 102 may be disposed on the mounting face 111. As shown in FIG. 3, the housing 100 may further comprise a mating face 112 on which the slot 101 is disposed for electrically connecting with the contact portion of a mating component. The mating face 112 and the mounting face 111 may be two opposing main surfaces of the housing 100 in the mating direction. The channels 103 may extend from the mating face 112 to the mounting face 111. For example, the channels 103 may be arranged in the side walls of the housing 100. In the embodiments according to the present application, a seal 300 may be provided on the mounting face 111.

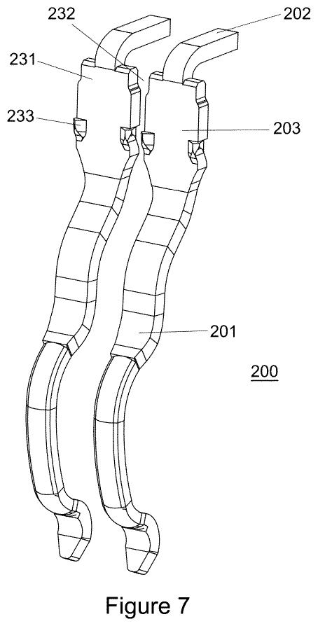

In some exemplary embodiments, the plurality of conductive elements 200 of the card edge connector 1 may be arranged in the longitudinal direction thereof in an array having two rows, as shown in FIG. 7. In the shown exemplary embodiment, the two rows of conductive elements extend substantively parallel to each other in the longitudinal direction.

In the embodiments according to the present application, each one of conductive elements 200 is held respectively in the channel 103 of the housing 100.

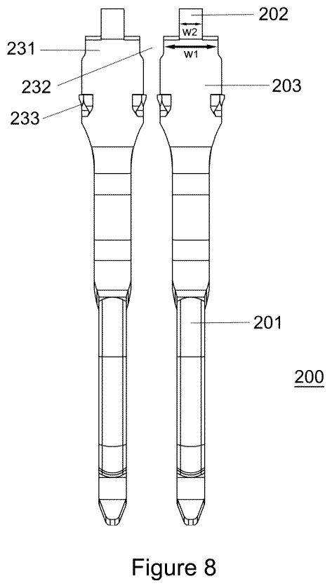

Referring to FIGS. 7 to 8, each of the plurality of conductive elements 200 of the card edge connector 1 may comprise a mating contact portion 201, a mounting end 202 as well as an intermediate portion 203 that connects the mating contact portion 201 and the mounting end 202.

In some exemplary embodiments, the mating contact portion 201 may curve towards the slot 101, inwardly projecting and exposing to the slot 101 for forming the interface receiving the contact portion of a mating component. When the electronic elements are inserted within the slot 101, the mating contact portion 201 may contact and be electrically connected with the contact portion of a mating component. In some exemplary embodiments, the mounting end 202 may extend beyond the mounting face 111 to the outside of the housing 100 via the openings 102. In some exemplary embodiments, the mounting end 202 of each of conductive elements 200 may project out from the mounting face 111 of the housing 100. For example, the mounting end 202 may be electrically connected to the circuit board by soldering technology.

For example, the mounting end 202 may be directly or indirectly soldered to the circuit board by technology such as BGA (Ball Grid Array). In this way, a mating component such as a memory card may be electrically connected with the circuit board via the card edge connector 1.

The opening 102 may be sized and shaped such that the mounting end 202 of conductive element 200 may project out from the channels 103 via the opening 102. As shown in FIG. 2, the opening 102 may have larger areas than that of the cross-section of the mounting end 202 projecting out therefrom.

Referring to FIGS. 7 and 8, two adjacent conductive elements are shown. In some exemplary embodiments, the intermediate portion 203 of conductive elements 200 may be provided with a subportion 231 with the width reduced in the longitudinal direction on the portion adjacent to the mounting end 202, and a gap 232 may be formed between the subportion 231 of two adjacent ones of the conductive elements 200.

In some exemplary embodiments, as shown in FIG. 8, the width w1 of the subportion 231 in the longitudinal direction may be greater than the width w2 of the mounting end 202 in the longitudinal direction. The subportion 231 may be formed on the shoulder portions on the two sides of the engaged mounting end 202 of the intermediate portion 203. In some exemplary embodiments, one or more step portions may be formed on a portion of the subportion 231 opposing to the mounting end 202 in the length direction of conductive elements.

With further reference to FIG. 7, the intermediate portion 203 of conductive elements 200 may be provided with a projection 233 on the surfaces away from the corresponding side walls, and the projection 233 may form a positive fit with the recess provided on the two opposing surfaces of the separator between two adjacent ones of the channel 103, such that the displacement of the conductive element 200 in the mating direction is blocked and the conductive element 200 may be more accurately and firmly fixed in the housing 100. Although FIG. 7 illustratively shows the shape of the projection 233, the projection 233 may be any other shapes that is capable of forming a positive fit with the separator of the channels 103 so as to bring about the technical effect of fixing.

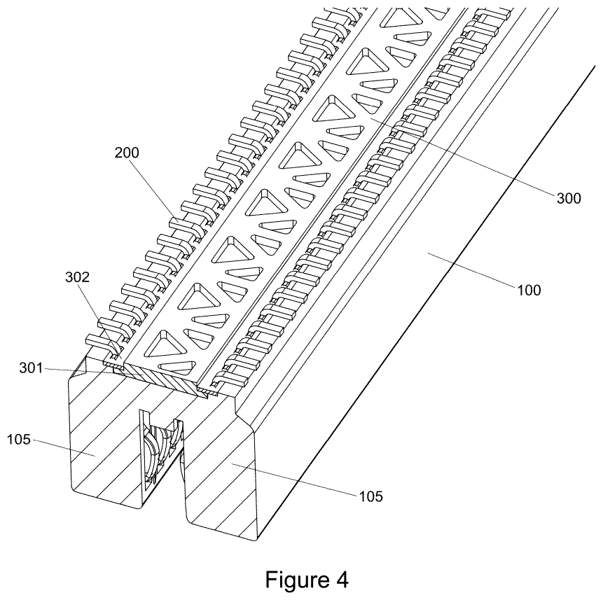

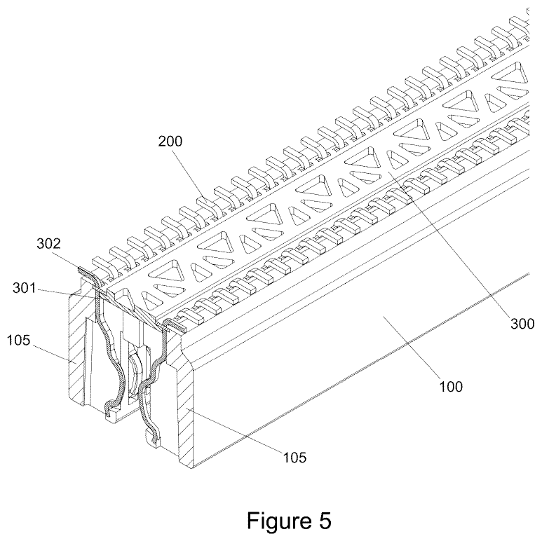

Referring back to FIGS. 4 to 5, the card edge connector 1 may further comprise a seal 300. The seal 300 may be disposed on the mounting face 111. The seal 300 covers and seals the openings 102 at the mounting end of the housing 100 (e.g., the side wall 105 of the housing 100).

According to exemplary embodiments of the present application, the seal 300 extends through the gap 232 formed between the subportions 231 of two adjacent conductive elements and connects with the side walls of the housing 100.

In some exemplary embodiments, the seal 300 may comprise a first sealing element 301. The first sealing element 301 may extend in the longitudinal direction of the card edge connector 1 and straddles the two rows of conductive elements in the direction transverse to the longitudinal direction. The two opposing side parts of the first sealing element 301 extending in the longitudinal direction extend through the gap 232 formed between the subportion 231 of two adjacent conductive elements 200 to connect with the side walls of the housing 100.

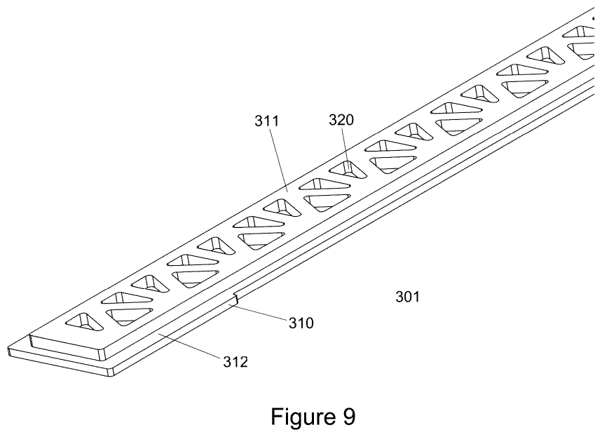

In some exemplary embodiments, the first sealing element 301 may comprise a platform portion 311 and a peripheral portion 312. The peripheral portion 312 may have a thickness less than the platform portion 311 in the mating direction F, as shown in FIG. 9.

In some exemplary embodiments, the edge of the peripheral portion 312 of the first sealing element 301 may be substantively straight in the longitudinal direction. The first sealing element 301 may be an integrated element formed by individually molding. The first sealing element 301 for the card edge connector 1 may be of the integral type or may include more than two separate pieces.

According to exemplary embodiments of the present application, the seal 300 may further comprise a second sealing element 302, as shown in FIGS. 4 and 5.

In some exemplary embodiments, the platform portion 311 of the first sealing element 301 may have a thickness d1, and the peripheral portion 312 may have a thickness d2, wherein d1 is greater than d2.

In some exemplary embodiments, the second sealing element 302 may be provided on the peripheral portion 312 of the first sealing element 301, extending towards the corresponding side walls 105 in the direction transverse to the longitudinal direction of the card edge connector 1 and out of the peripheral portion 312 to connect with the side walls 105 of the housing 100. For example, the second sealing element 302 may have a thickness d3 that is smaller than d1. In some exemplary embodiments, the sum of the thickness d2 of the peripheral portion 312 and the thickness d3 of the second sealing element 302 may be smaller than the thickness d1 of the platform portion 311. In particular, the sum of the thickness d2 of the peripheral portion 312 and the thickness d3 of the second sealing element 302 may be equal to the thickness d1 of the platform portion 311.

Preferably, the second sealing element 302 may be a sealant element with high temperature resistance, good insulation and good sealing properties. For example, the second sealing element 302 may be formed with a UV sealant.

According to the exemplary embodiments of the present application, a UV sealant may be applied on the peripheral portion 312 of the first sealing element 301 after the first scaling element 301 is mounted between the two rows of conductive elements, such that the UV sealant can be fully filled in the gap between the first sealing element and the housing 100. Then the UV sealant is cured to be shaped as the second sealing element 302. Accordingly, the openings 102 on the mounting face 111 may be completely sealed through the first sealing element 301 and the second sealing element 302.

In such way, the first sealing element 301 is utilized to substantively seal the openings 102 formed on the mounting face 111 over a larger extent and a larger area, and the second scaling element 302 is utilized to completely seal the portions of the openings formed on the mounting face 111 which is not closed by the first closure member 301 over a local extent. Thereby, the mounting face of the card edge connector 1 according to the embodiments of the present application is completely sealed by the seal 300, blocking the penetration of other contaminants, such as water vapor or dust flow, that may be generated during the soldering operation or at any other time during the manufacture or use of the electronic assembly containing the card edge connector 1, and thereby making the electrical connection to a mating component more reliable, signal transmission more stable, improving the overall performance of a mating component. Further, the seal 300 of the card edge connector 1 according to the present application has rather low manufacturing cost with a guarantee of good sealing property.

Referring to FIG. 9, according to some exemplary embodiments of the present application, the platform portion 311 of the first sealing element 301 may be provided with a plurality of grooves 320. The dimensions of the grooves 320 in the mating direction F may be smaller than that of rest of the platform portion 311. The grooves 320 may have a triangle cross-sectional shape. Alternatively, the grooves 320 may have any other cross-sectional shapes. By providing grooves 320 on the platform portion 311, it is possible to reduce the material used for the seal and thus reduce the costs while ensuring the scaling property. In addition, it is also possible to reduce the overall weight of the card edge sealant.

A step portion 310 may be provided on the peripheral portion 312 of the first sealing element 301, and the width of the step portion 310 in the direction transverse to the longitudinal direction may be greater and the step portion 310 is configured to form a positive fit with the portion on the mounting face 111 of the housing 100 that is not provided with conductive elements, such that the first sealing element 301 is more closely fitted to the mounting face 111 of the housing 100.

In some embodiments of the present application, the first sealing element 301 and the housing 100 may be configured as an integrated molded member of high temperature thermoplastic material. There is no opening in the surface of the integrated molded member facing the circuit boards. Therefore, the card edge connector according to the embodiment may effectively block the contaminants when being soldered to the circuit boards, thus ensuring reliable electrical connection and information transmission between the mating contact portion of conductive elements in the slot of the card edge connector and the contact portion of a mating component. In addition, this integrated molded member makes manufacturing simpler by eliminating the assembly process of the seals, and facilitates the automated production line, thus improving labor productivity.

In some exemplary embodiments, a stop 120 may be provided on the mounting end of the corresponding side wall 105 of the housing 100, and the mounting end 202 of the conductive element 200 may bend towards the corresponding stop 120. Optionally, the mounting end 202 of the conductive element 200 may be embedded in the stop 120 and form a positive fit with the stop 120 of the side walls. The curving portion of the mounting end 202 may act in cooperation with the stop 120 of the side walls so as to work coordinately to reduce the risk of conductive elements 200 from being relatively displaced with respect to the housing 100 in the mating direction, such that the conductive elements in the housing can be positioned more accurately.

Having thus described several aspects of embodiments of card edges connectors, it is to be appreciated that various alterations, modifications, and improvements will readily occur to those skilled in the art. Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

For example, although many inventive aspects are shown and described with reference to a card edge connector having a vertical configuration, it should be appreciated that aspects of the present disclosure is not limited in this regard, as any of the inventive concepts, whether alone or in combination with one or more other inventive concepts, may be used in other types of electrical connectors, such as backplane connectors, daughter card connectors, cable connectors, stacking connectors, mezzanine connectors, I/O connectors, chip sockets, Gen Z connectors, etc.

As another example, although mounting tails were illustrated as surface mounting elements, other configurations may also be used, such as press fit “eye of the needle” compliant sections that are designed to fit within vias of printed circuit boards, spring contacts, solderable pins, etc., as aspects of the present disclosure are not limited to the use of any particular mechanism for attaching connectors to printed circuit boards.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

In the description of the present application, it shall be noted that the orientation or position indicated by locative wordings such as “inside”, “outside”, “transverse”, “longitudinal”, “perpendicular” and the same are generally based on the orientation or position shown in the drawings, which are only for the convenience of describing herein and simplifying the same. In the absence of a contrary description, these locative wordings do not indicate and imply that the referred device or element must have a particular orientation or be constructed and operated in a particular orientation, and thus it cannot be understood as a limitation to the protection scope of the present application.

It shall be noted that the terms used herein are only intended to describe specific embodiments, and are not intended to limit exemplary embodiments according to the present application. As used herein, the indefinite article “an” or “a” does not exclude the plural unless it is specifically stated. It shall be further understood that the terms “comprise”, “have” and any of their variants are meant to cover non-exclusive inclusions.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. An electrical connector comprising:
a housing comprising a mating face, a mounting face opposite the mating face, a side wall having a plurality of channels extending to the mounting face, and a slot recessed from the mating face and extending along the side wall;
a plurality of conductive elements disposed in respective channels of the plurality of channels of the side wall of the housing, each of the plurality of conductive elements comprising a mating end having a mating contact portion curving into the slot, a mounting end extending out of the mounting face, and an intermediate portion joining the mating end and mounting end; and
a seal disposed at the mounting face, the seal comprising a first sealing element and a second sealing element at least partially disposed on the first sealing element.

2. The electrical connector of claim 1, wherein:
the second sealing element extends beyond an edge of the first sealing element so as to block openings of the plurality of channels of the side wall of the housing at the mounting face.

3. The electrical connector of claim 1, wherein:
the first sealing element comprises plastic; and
the second sealing element adheres to the first sealing element.

4. The electrical connector of claim 3, wherein:
the first sealing element comprises thermoplastic; and
the second sealing element comprises silicon.

5. The electrical connector of claim 1, comprising:
a plurality of gaps between subportions of the intermediate portions of adjacent conductive elements of the plurality, wherein:
the second sealing element extends through the plurality of gaps to the side wall.

6. The electrical connector of claim 1, wherein:
the body of the housing is elongated in a longitudinal direction; and
for each conductive element of the plurality of conductive elements, the intermediate portion is wider than the mounting end and engages the side wall of the housing so as to be restrained from moving in the longitudinal direction.

7. The electrical connector of claim 6, wherein:
for each of the plurality of conductive elements, the intermediate portion comprises a projection protruding away from the side wall of the housing and extend into the recesses of respective separators so as to be restrained from moving in a transverse direction perpendicular to the longitudinal direction.

8. The electrical connector of claim 2, wherein:
the first sealing element comprises a platform portion and a peripheral portion thinner than the platform portion and comprising the edge of the first sealing element; and
the second sealing element is disposed on the peripheral portion of the first sealing element and extends beyond the peripheral portion toward the side wall.

9. The electrical connector of claim 8, wherein:
the platform portion of the first sealing element comprises a plurality of grooves recessed from the mounting face.

10. The electrical connector of claim 8, wherein:
the wall comprises a stop at the mounting face and flush with the second sealing element;
the mounting ends of the plurality of conductive elements bend towards a respective stop; and
the second sealing element is disposed between the platform portion and the respective stops.

11. The electrical connector of claim 10, wherein:
the platform portion extends beyond the flushed surface of the second sealing element and the stop of the side wall.

12. The electrical connector of claim 1, wherein:
the electrical connector is configured to transmit signals at a speed specified by DDR5 standard.

13. An electrical connector comprising:
a housing comprising a mating face, a mounting face opposite the mating face, and a plurality of channels extending to the mounting face;
a plurality of conductive elements disposed in respective channels of the plurality of channels of the housing, each of the plurality of conductive elements comprising a mating end, a mounting end opposite the mating end and extending out of the plurality of channels at the mounting face, and an intermediate portion joining the mating end and mounting end; and
a seal disposed at the mounting face of the housing, wherein, for each of the plurality of conductive elements:
a subportion of the intermediate portion directly connected to the mounting end is embedded in the seal.

14. The electrical connector of claim 13, wherein:
the seal comprises plastic and sealant connected to the plastic; and
the subportions of the intermediate portions of the plurality of conductive elements are embedded in the sealant of the seal.

15. The electrical connector of claim 13, wherein, for each of the plurality of conductive elements:
the mounting end is narrower than the subportion of the intermediate portion.

16. The electrical connector of claim 15, wherein:
the intermediate portion abuts the plastic of the seal and a respective side wall of the housing on opposite sides.

17. The electrical connector of claim 16, wherein:
the plastic of the seal comprises a platform portion and a peripheral portion surrounding the platform portion; and
the intermediate portion is at least partial disposed between the peripheral portion of the plastic of the seal and the respective side wall of the housing.

18. The electrical connector of claim 17, wherein:
the sealant is stacked on the peripheral portion of the plastic; and
the platform portion of the plastic is thicker than the stack of the sealant and the peripheral portion of the plastic.

19. A method of manufacturing an electrical connector comprising a plurality of conductive elements held by a housing, the housing comprising a mating face, a mounting face opposite the mating face, a side wall having a plurality of channels extending to the mounting face, and a slot recessed from the mating face and extending along the side wall, and each of the plurality of conductive elements comprising a mating end, a mounting end, and an intermediate portion joining the mating end and mounting end, the method comprising:
inserting the plurality of conductive elements into individual channels of the plurality of channels of the side wall of the housing such that, for each of the plurality of conductive element, a mating contact portion of the mating end curves into the slot, and the mounting end extends out of the mounting face; and
disposing a seal at the mounting face of the housing comprising flowing a sealant around subportions of the intermediate portions of the plurality of conductive elements.

20. The method of claim 19, comprising:
curing the sealant such that the subportions of the intermediate portions of the plurality of conductive elements are embedded in the sealant.
